(19) United States
(12) Patent Application Publication
(10) Pub. No.: US 2015/0115713 A1
(43) Pub. Date: Apr. 30, 2015

(54) POWER SUPPLY APPARATUS

(71) Applicant: SAMSUNG ELECTRO-MECHANICS CO., LTD., Suwon-Si (KR)

(72) Inventors: Jae Kuk KIM, Daejeon-si (KR); Chong Eun KIM, Daejeon-si (KR); Don Sik KIM, Gunpo-si (KR)

(21) Appl. No.: 14/529,030

(22) Filed: Oct. 30, 2014

(30) Foreign Application Priority Data
Oct. 31, 2013 (KR) 10-2013-0131194

(51) Int. Cl. H02J 1/08; H02J 7/00; H02M 7/219

(52) U.S. Cl. CPC H02J 1/08; H02M 7/219; H02J 7/007
USPC 307/23

(57) ABSTRACT

A power supply apparatus includes a master circuit part charging a battery initially, supplying energy to a load that is a light load, and charging the battery when discharged; and a slave circuit part having a common output terminal with the master circuit part and supplying energy to the load that is a heavy load along with the master circuit part by distributing the load among them, wherein the master circuit part includes a rechargeable battery therein. Energy is supplied to a load using a battery at a low load that is a half load or less in a power supply circuit, thereby increasing energy efficiency.

### CROSS REFERENCE(S) TO RELATED APPLICATIONS

This application claims the foreign priority benefit under 35 U.S.C. Section 119 of Korean Patent Application Serial No. 10-2013-0131194, entitled “Power Supply Apparatus” filed on Oct. 31, 2013, which is hereby incorporated by reference in its entirety into this application.

### BACKGROUND OF THE INVENTION

1. Technical Field

The present disclosure relates to a power supply apparatus, and more particularly, to a power supply apparatus capable of improving energy efficiency under a low load that is a half load or less.

2. Description of the Related Art

As energy consumption becomes a social issue, more attention is paid to energy conversion efficiency. In particular, energy efficiency is especially important for server power and thus it is necessary to factor server power technology and an essential factor to consider in order to enter the server market. For example, in the case of CSCI-titanium, for a load of 10%-20%-50%-100%, high efficiency of 90%-94%-96%-91% is required. It is especially difficult to improve efficiency under a half load or less, and there is an increasing demand for high efficiency under a very low load of 10% or less. Incidentally, some server power supplies commonly have a redundant structure in which several power supplies are connected to one load in order to cope with various faults. In this case, efficiency under a low load condition may be increased by performing a cold redundant control that operates a master circuit part only when load becomes smaller. Even in this manner, however, efficiency is not improved more than that of a single module, and it is difficult to improve efficiency under a very low load.

### SUMMARY

An object of the present teaching is to provide a power supply apparatus capable of improving energy efficiency under a low load that is a half load or less.

According to an exemplary embodiment, there is provided a power supply apparatus, including a master circuit part charging a battery initially, supplying energy to a load that is a light load, and charging the battery when discharged; and a slave circuit part having a common output terminal with the master circuit part and supplying energy to the load that is a heavy load along with the master circuit part by distributing the load among them, wherein the master circuit part includes a rechargeable battery therein.

The master circuit part may further include an initial battery charger for charging the battery initially.

The initial battery charger may include a transformer receiving AC voltage and generating output voltage having an amplitude different from that of input voltage according to a turns ratio between primary and secondary windings; a switch element producing intermittent current flowing in the primary winding of the transformer; and a diode for rectifying AC voltage induced in the secondary winding of the transformer into DC voltage. The switch element may be a MOSFET.

The initial battery charger may include an AC/DC converting unit that receives AC voltage from an AC voltage source and converts it into a DC voltage; a transformer that converts the DC voltage converted by the AC/DC converting unit into DC voltage having a different amplitude according to the turns ratio between the primary and secondary windings; and a rectifying unit rectifying an AC component mixed in the DC voltage induced in the secondary winding of the transformer into a DC component.

The power supply apparatus may further include an inductor that removes a high-frequency noise component mixed in current supplied to the battery through the rectifying unit.

The AC/DC converting unit may be configured as a full bridge circuit that includes a first switch element with its one terminal connected to the AC voltage source; a first diode connected to the first switch element in series, a second diode connected to the first switch element in parallel, and a second switch element connected to the second diode in series. The first and second switch elements may be MOSFETs.

The rectifying unit may be configured as a half bridge circuit that includes a first output diode connected to one terminal of the secondary winding of the transformer in series, and a second output diode connected to a unit circuit consisting of the secondary winding and the first output diode in parallel.

The master circuit part may be configured to supply energy to a load that is a half load or less.

The slave circuit part may be configured to supply power for charging the battery if a voltage of the battery is a reference voltage or less.

### BRIEF DESCRIPTION OF THE DRAWINGS

FIG. 1 is a circuit diagram of a power supply apparatus according to an exemplary embodiment of the present teaching;

FIG. 2 is a circuit diagram of an initial battery charger in a master circuit part of the power supply apparatus of FIG. 1 according to an exemplary embodiment;

FIG. 3 is a circuit diagram of an initial battery charger in a master circuit part of the power supply apparatus of FIG. 1 according to another exemplary embodiment; and

FIG. 4A to 4C are circuit diagrams each illustrating an operation in respective modes of the power supply apparatus according to the present disclosure.

### DESCRIPTION OF THE PREFERRED EMBODIMENTS

Terms and words used in the present specification and claims are not to be construed as a general or dictionary meaning, but are to be construed as meaning and concepts meeting the technical ideas of the present invention based on a principle that the inventors can appropriately define the concepts of terms in order to describe their own inventions in the best mode.

Throughout the present specification, unless explicitly stated otherwise, “comprising” any components will be understood to imply the inclusion of other elements rather than the exclusion of any other elements. The terms “part,” “module,” “device” or the like used in the specification means a unit of processing at least one function or operation and may be implemented by hardware or software or a combination of hardware and software.

Hereinafter, exemplary embodiments of the present disclosure will be described in detail with reference to the accompanying drawings.

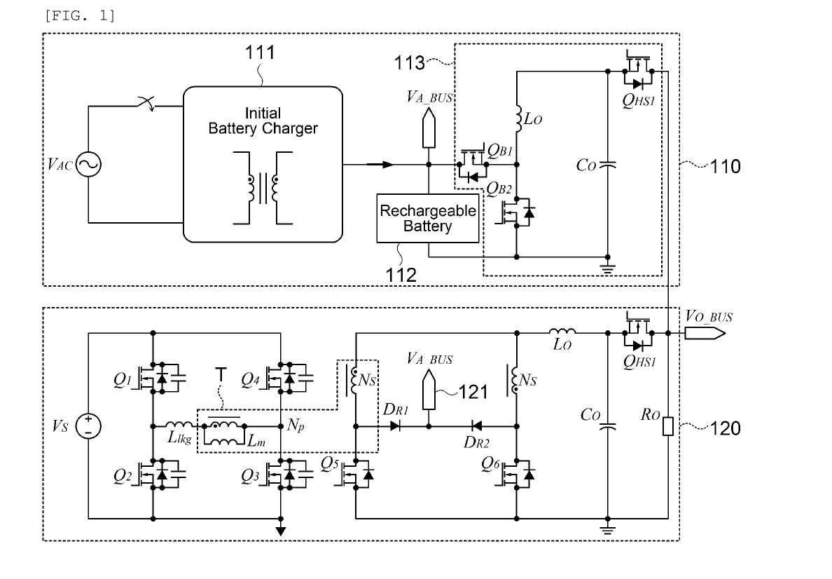

FIG. 1 is a circuit diagram of a power supply apparatus according to an exemplary embodiment.

Referring to FIG. 1, the power supply apparatus according to the exemplary embodiment includes a master circuit part 110 and a slave circuit part 120.

The master circuit part 110 charges a battery initially, supplies energy to a load that is a light load, and charges a discharged battery. In the master circuit part 110, a rechargeable battery 112 is provided. Further, the master circuit part 110 includes a buck converter unit 113 for supplying energy to a load that is a half load or less in a normal operation state and charging the battery 112 when it is discharged. Here, the buck converter unit 113 may be a bidirectional synchronous buck converter (BSBC).

The slave circuit part 120 has a common output terminal with the master circuit part 110 and supplies energy to the load that is a heavy load along with the master circuit part 110 by distributing the load among them. The slave circuit part 120 is configured with a phase-shift full bridge (PSFB) and V_{A}_{_{—}}_{BUS} is provided at the secondary side of a transformer T as a bus dedicated for monitoring battery information with the master circuit part 110.

The master circuit part 110 may further include an initial battery charger 111 for charging the battery 112 initially.

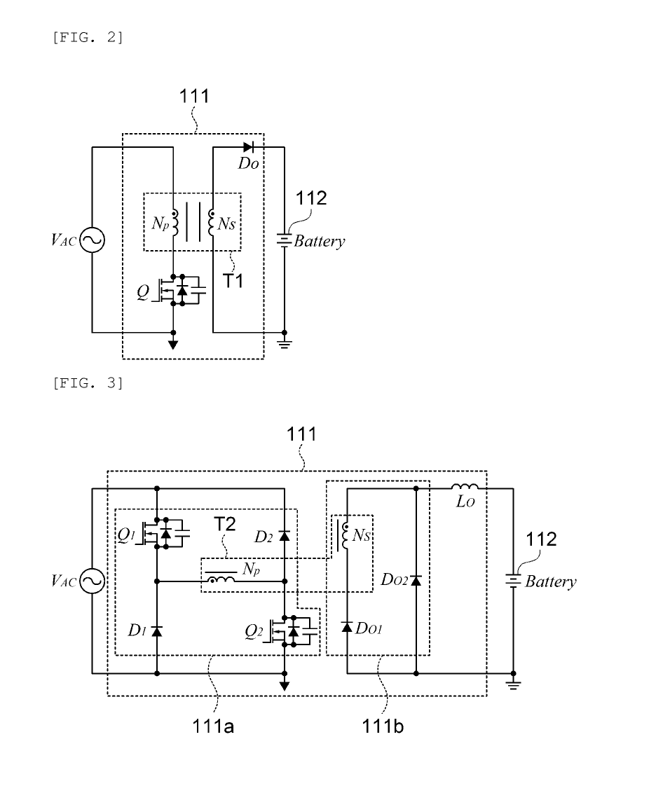

As shown in FIG. 2, the initial battery charger 111 according to an exemplary embodiment may include a transformer T1 that receives AC voltage from an AC voltage source V_{AC} to generate an output voltage having an amplitude different from its input voltage according to the turns ratio between the primary and secondary windings; a switch element Q that produces intermittent current flowing in the primary winding Nₚ of the transformer T1; a diode Do that rectifies AC voltage induced in the secondary winding Nₛ of the transformer T1 into DC voltage. The switch element Q may be a MOSFET. As will be appreciated, the switch element Q is not limited to the MOSFET but may be a typical bipolar transistor.

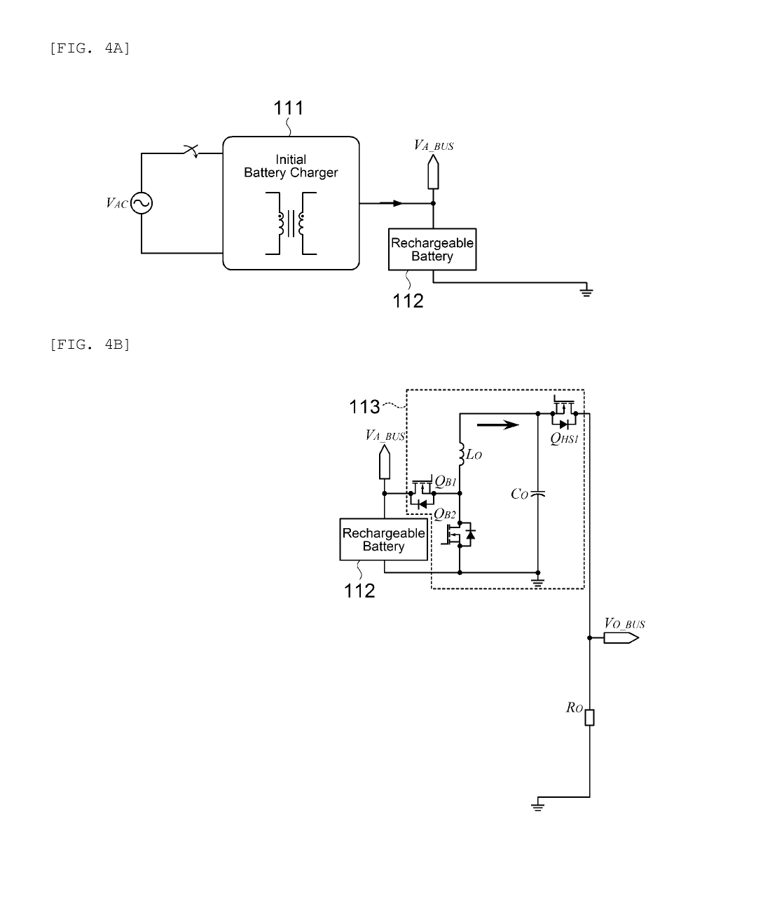

According to another exemplary embodiment, the initial battery charger 111 may be configured as shown in FIG. 3. That is, the initial battery charger 111 according to another exemplary embodiment may include an AC/DC converting unit 111a that receives AC voltage from an AC voltage source V_{AC} to convert it into DC voltage; a transformer T2 that converts the DC voltage converted by the AC/DC converting unit 111a into a DC voltage having a different amplitude according to the turns ratio between the primary and secondary windings; and a rectifying unit 111b rectifying an AC component mixed in the DC voltage induced in the secondary winding Nₛ of the transformer T2 into a DC component. Preferably, the initial battery charger 111 may further comprise an inductor Lo that removes a high-frequency noise component mixed in the current supplied to the battery 112 through the rectifying unit 111b.

In addition, the AC/DC converting unit 111a may be configured as a full bridge circuit that includes a first switch element Q1 with its one terminal connected to the AC voltage source, a first diode D1 connected to the first switch element Q1 in series, a second diode D2 connected to the first switch element Q1 in parallel, and a second switch element Q2 connected to the second diode D2 in series. The first and second switch elements Q1 and Q2 may be MOSFETs. Again, as will be appreciated, the first and second switch elements Q1 and Q2 may be bipolar transistors.

In addition, the rectifying unit 111b may be configured as a half bridge circuit that includes a first output diode Do1 connected to one terminal of the secondary winding Nₛ of the transformer T2 in series, and a second output diode Do2 connected to a unit circuit comprising the secondary winding Nₛ and the first output diode Do1 in parallel.

Further, the master circuit part 110 is configured to supply energy to a load that is a half load or less.

Further, the slave circuit part 120 is configured to supply power for charging the battery 112 if the voltage level of the battery 112 is at a reference voltage level or less.

Hereinafter, the operation of the power supply apparatus thus configured according to an exemplary embodiment will be described.

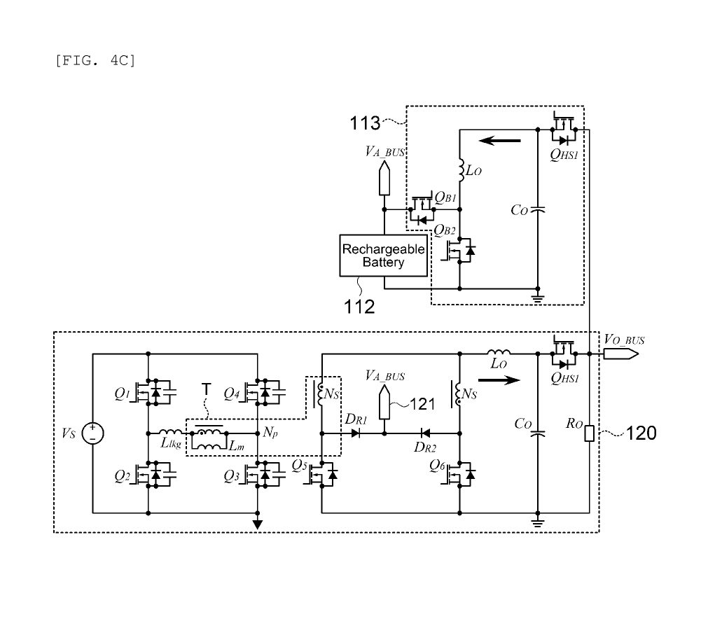

FIG. 4A to 4C are circuit diagrams for illustrating operations in modes of the power supply apparatus according to the present disclosure.

Initially, the battery 112 is charged by the initial battery charger 111 as shown in FIG. 4A and then power is supplied to a load using the energy in the battery 112 only through the buck converting unit 113 that is a half load or less as shown in FIG. 4B, thereby increasing efficiency. Further, if the voltage level of the battery 112 is at the reference voltage level or less, the battery 112 is charged through the buck converter unit 112 from the slave circuit part 120 as shown in FIG. 4C. Using the slave circuit part 120 to charge the battery 112 may be also used in charging the battery initially.

As described above, the power supply apparatus according to the present disclosure includes the rechargeable battery in the master circuit part of a power supply circuit such that energy is supplied to a load using the battery being a low load that is a half load or less, thereby increasing energy efficiency.

Although the exemplary embodiments of the present invention have been disclosed for illustrative purposes, the present invention is not limited thereto, but those skilled in the art will appreciate that various modifications, additions and substitutions are possible, without departing from the scope and spirit of the invention as disclosed in the accompanying claims. Therefore, the true scope of the present invention to be protected should be defined only by the appended claims and it is apparent to those skilled in the art that technical ideas equivalent thereto are within the scope of the present invention.

What is claimed is:

1. A power supply apparatus, comprising:
a master circuit part charging a battery initially, supplying energy to a load that is a light load, and charging the battery when discharged; and
a slave circuit part having a common output terminal with the master circuit part and supplying energy to the load that is a heavy load along with the master circuit part by distributing the load among them,
wherein the master circuit part includes a rechargeable battery therein.

2. The power supply apparatus according to claim 1, wherein the master circuit part further includes an initial battery charger for charging the battery initially.

3. The power supply apparatus according to claim 2, wherein the initial battery charger includes:
a transformer receiving AC voltage and generating an output voltage having an amplitude different from that of its input voltage according to a turns ratio between primary and secondary windings thereof;
a switch element producing intermittent current flowing in the primary winding of the transformer; and
a diode rectifying AC voltage induced in the secondary winding of the transformer into DC voltage.

4. The power supply apparatus according to claim 3, wherein the switch element is a MOSFET.

5. The power supply apparatus according to claim 2, wherein the initial battery charger includes:
an AC/DC converting unit that receives AC voltage from an AC voltage source to convert it into DC voltage;
a transformer that converts the DC voltage converted by the AC/DC converting unit into DC voltage having a different amplitude according to the turns ratio between the primary and secondary windings; and
a rectifying unit rectifying an AC component mixed in the DC voltage induced in the secondary winding of the transformer into a DC component.

6. The power supply apparatus according to claim 5, further comprising an inductor that removes a high-frequency noise component mixed in current supplied to the battery through the rectifying unit.

7. The power supply apparatus according to claim 5, wherein the AC/DC converting unit is configured as a full bridge circuit that includes
a first switch element with its one terminal connected to the AC voltage source,
a first diode connected to the first switch element in series,
a second diode connected to the first switch element in parallel, and
a second switch element connected to the second diode in series.

8. The power supply apparatus according to claim 7, wherein the first and second switch elements are MOSFETs.

9. The power supply apparatus according to claim 5, wherein the rectifying unit is configured as a half bridge circuit that includes
a first output diode connected to one terminal of the secondary winding of the transformer in series, and
a second output diode connected to a unit circuit consisting of the secondary winding and the first output diode in parallel.

10. The power supply apparatus according to claim 1, wherein the master circuit part is configured to supply energy to the load that is a half load or less.

11. The power supply apparatus according to claim 1, wherein the slave circuit part is configured to supply power for charging the battery if a voltage level of the battery is at a reference voltage level or less.

12. The power supply apparatus according to claim 1, wherein the slave circuit part includes a bus dedicated for monitoring battery information with the master circuit part.
